(19) United States
(12) Patent Application Publication
(10) Pub. No.: US 2010/0328282 A1
(43) Pub. Date: Dec. 30, 2010

(54) IMAGE DISPLAY SYSTEM

(75) Inventors: Po-Kun SU, Xizhi City (TW); Ryuji Nishikawa, Hsinchu City (TW)

Correspondence Address: LIU & LIU, 444 S. FLOWER STREET, SUITE 1750, LOS ANGELES, CA, 90071, US

(73) Assignee: CHIMEI INNOLUX CORPORATION, Jhunan Science Park (TW)

(21) Appl. No.: 12/826,574

(22) Filed: Jun. 29, 2010

(30) Foreign Application Priority Data
Jun. 29, 2009 (TW) 098121808

(51) Int. Cl. G09G 3/32; G06F 3/038

(52) U.S. Cl. 345/206; 345/82; 345/83

(57) ABSTRACT

An image display system comprising a display panel is disclosed. The display panel, having a display region and a non-display region adjacent thereto, includes an upper substrate, a lower substrate opposing to the upper substrate, a plurality of organic light-emitting diodes on the lower substrate, and a filling layer. The upper substrate includes a light transmittable layer within the non-display region of the upper substrate, and the light transmittable layer has a transmittance at a specific wavelength of light. The filling layer including a light curable material is disposed between the upper and lower substrates, covering the display region and the non-display region of the lower substrate. The light curable material is cured by absorption of the specific wavelength of light.

### CROSS REFERENCE TO RELATED APPLICATIONS

This application claims the right of priority based on Taiwan Patent Application No. 98121808 entitled “IMAGE DISPLAY SYSTEM” filed on Jun. 29, 2009, which is incorporated herein by reference and assigned to the assignee herein.

### FIELD OF THE INVENTION

This invention relates to an image display system, and more particularly relates to an organic light-emitting diode (OLED) display panel.

### BACKGROUND OF THE INVENTION

OLED display device is widely applied in various electronic products due to its strengths of low power consumption, compactness and low costs.

FIG. 1 illustrates a conventional OLED display panel 100. The OLED display panel 100 includes a lower substrate 110, an upper substrate 180, a white organic light-emitting diode 120, a sealant material 190, and color filters 140B, 140G and 140R. The white organic light-emitting diode 120 is disposed on the lower substrate 110, including an upper electrode 128, a light-emitting layer 125 and a lower electrode 122. The color filters 140B, 140G and 140R are sandwiched between the white organic light-emitting diode 120 and upper substrate 180.

Additionally, the color filters 140B, 140G and 140R are directly attached to the white organic light-emitting diode 120. This creates air gaps between substrates that may adversely lead to substrate cracking. On the other hand, moisture penetration still takes place and degrades the white organic light-emitting diode 120 although there provides the sealant material 190 to joint the lower substrate 110 with the upper substrate 180 together.

Accordingly, a display panel capable of solving the aforementioned drawbacks is desirable.

### SUMMARY OF THE INVENTION

In view of the aforementioned drawbacks in prior art, one embodiment of the invention provides an image display system comprising a display panel. The display panel, having a display region and a non-display region adjacent thereto, includes an upper substrate, a lower substrate opposing to the upper substrate, a plurality of organic light-emitting diodes on the lower substrate, and a filling layer. The upper substrate includes a light transmittable layer within the non-display region of the upper substrate, and the light transmittable layer has a transmittance at a specific wavelength of light. The filling layer including a light curable material is disposed between the upper and lower substrates, covering the display region and the non-display region of the lower substrate. The light curable material is cured by absorption of the specific wavelength of light.

In other embodiments of the invention, a display device and an electronic device incorporating such a display panel are also disclosed.

### BRIEF DESCRIPTION OF THE DRAWINGS

FIG. 1 illustrates a conventional OLED display panel.

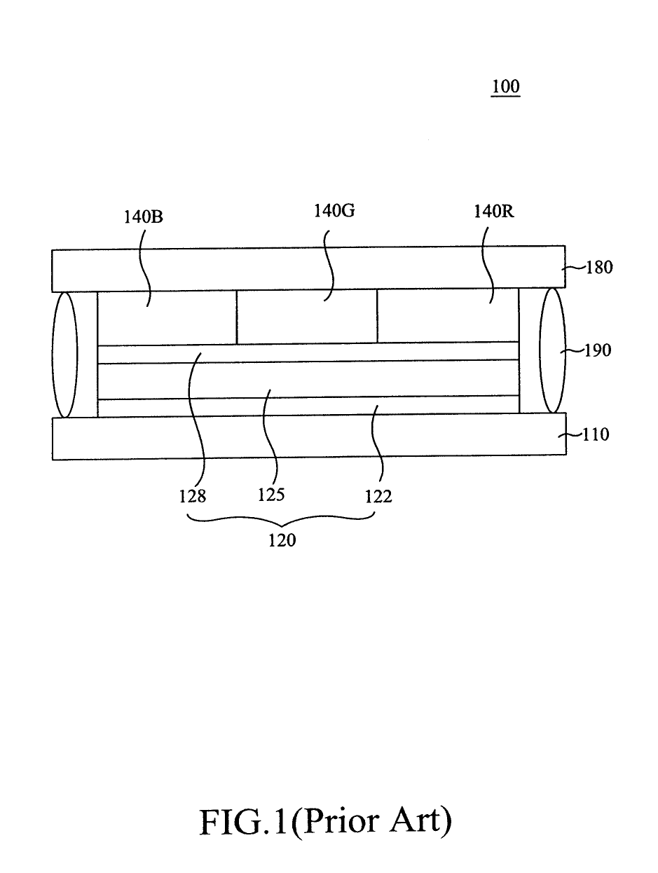

FIG. 2A is a plan view illustrating an OLED display panel in accordance with one embodiment of the present invention.

FIG. 2B is a cross-sectional view taken along with a cross-section line AA′ of FIG. 2A.

FIG. 3A is a plan view illustrating an OLED display panel in accordance with another embodiment of the present invention.

FIG. 3B is a cross-sectional view taken along with a cross-section line BB′ of FIG. 3A.

FIG. 4 is a plan view illustrating an OLED display panel in accordance with another embodiment of the present invention.

FIG. 5 illustrates an electronic device in accordance with one embodiment of the present invention.

### DETAILED DESCRIPTION OF THE INVENTION

The present invention may best be understood by reference to the following description in conjunction with the accompanying drawings, in which similar reference numbers represent similar elements. Any devices, components, materials, and steps described in the embodiments are only for illustration and not intended to limit the scope of the present invention.

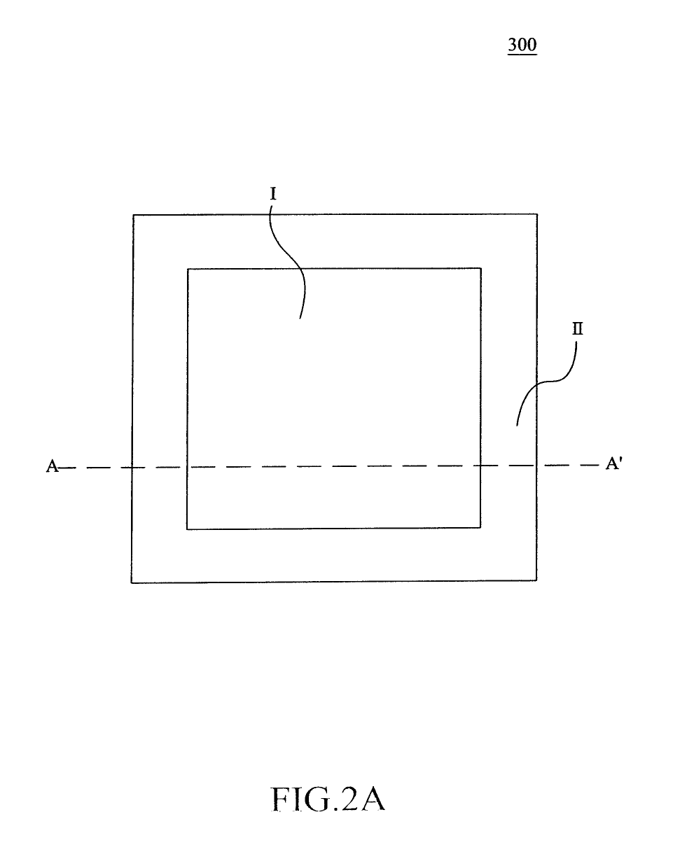

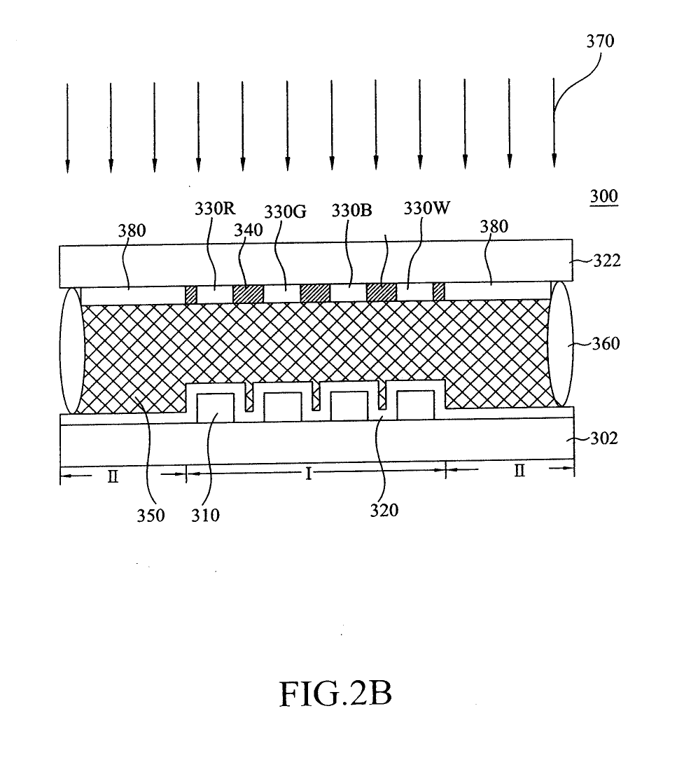

FIG. 2A is a plan view illustrating an OLED display panel in accordance with one embodiment of the present invention. FIG. 2B is a cross-sectional view taken along with a cross-section line AA′ of FIG. 2A.

Referring to FIG. 2A, the OLED display panel 300 includes a display region “I” and a non-display region “II” . Referring to FIG. 2B, one embodiment of the invention discloses that a light transmittable layer 380 is within the non-display region and has a transmittance at a specific wavelength of light. The specific wavelength is, for example, is between 300 nm and 430 nm, and the transmittance can be larger than 10%. According, a filling layer 350 (as described later) of this embodiment preferably employs light curable materials that can be cured by light having a wavelength ranged between 300 nm and 430 nm.

The OLED display panel 300 includes an upper substrate 322, a lower substrate 302, the filling layer 350 therebetween, and a sealant material 360 to joint the upper substrate 322 with the lower substrate 302. On the lower substrate 302, there are disposed a plurality of organic light-emitting diodes 310 and a passivation layer 320 covering the organic light-emitting diodes 310. The organic light-emitting diodes 310 can be white organic light-emitting diode and emit light having a wavelength ranged between 430 nm and 750 nm. Below the upper substrate 322 within display region “I”, there are disposed a light shielding layer 340 and color filters 330R, 330G, 330B, 330W. In this embodiment, the filling layer 350 does not degrade performance of the organic light-emitting diodes 310 because it cannot be cured by light emitted from the organic light-emitting diodes 310.

Specifically, in this embodiment, a light transmittable layer 380 is further disposed below the upper substrate 322 within the non-display region “II”.

And, a area ratio of the light transmittable layer 380 to the non-display region “II” equals 1. Furthermore, the filling layer 350 is sandwiched between the upper substrate 322 and lower substrate 302, crossovering the display region “I” and non-display region “II” of the lower substrate 302. The filling layer 350 includes a light curable material that can be cured by absorption of light with a wavelength ranged from 300 nm to 430 nm.

In this embodiment, the light transmittable layer 380 can be color filters, such as blue resist layer, green resist layer or red resist layer. The light transmittable layer 380, for example, is made of blue resist having a transmittance at a specific wavelength of light between 300 nm and 430 nm. The transmittance is preferably larger than 10%. Additionally, a light source 370 is utilized to emit ultraviolet (UV) light. The filling layer 350, for example, can be made of epoxy, acrylic, polyester, or polyurethane. In practical application, the filling layer 350 may employ T58-UR009 of Nagase.

Referring to FIG. 2B, the filling layer 350 is cured by exposing to the light source 370. Specifically, in this embodiment, the overall non-display region “II” is fully occupied by the light transmittable layer 380, so that light from the light source 370 can pass therethrough and directly illuminate the filling layer 350 thereunder. The filling layer 350 is further cured accordingly. In this embodiment, not only the filling layer 350 under the light transmittable layer 380 but the filling layer 350 under the color filters 330R, 330G, 330B, and 330W are cured, thus, moisture penetration into the display panel can be effectively avoided. The filling layer 350 can be UV curable material.

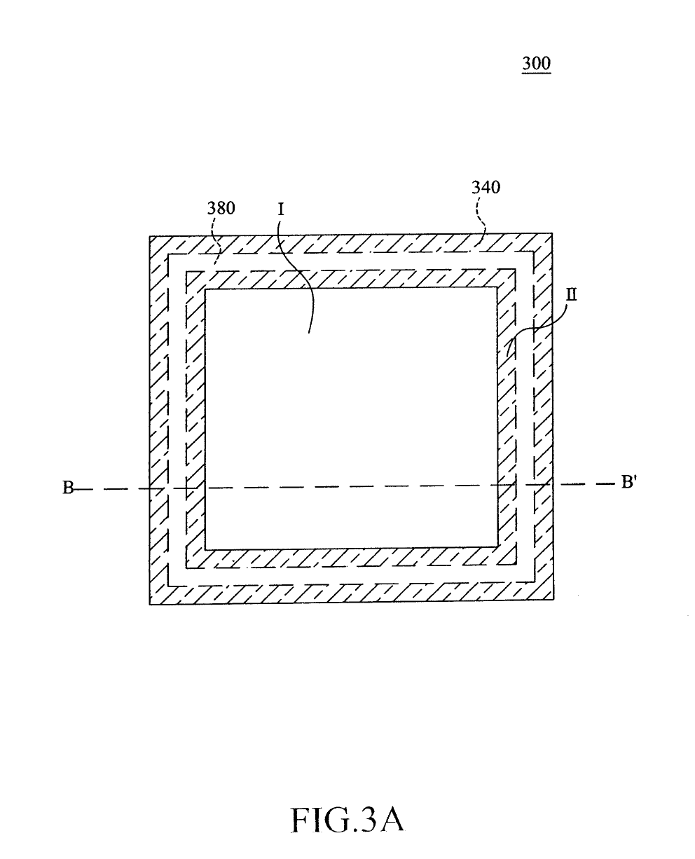

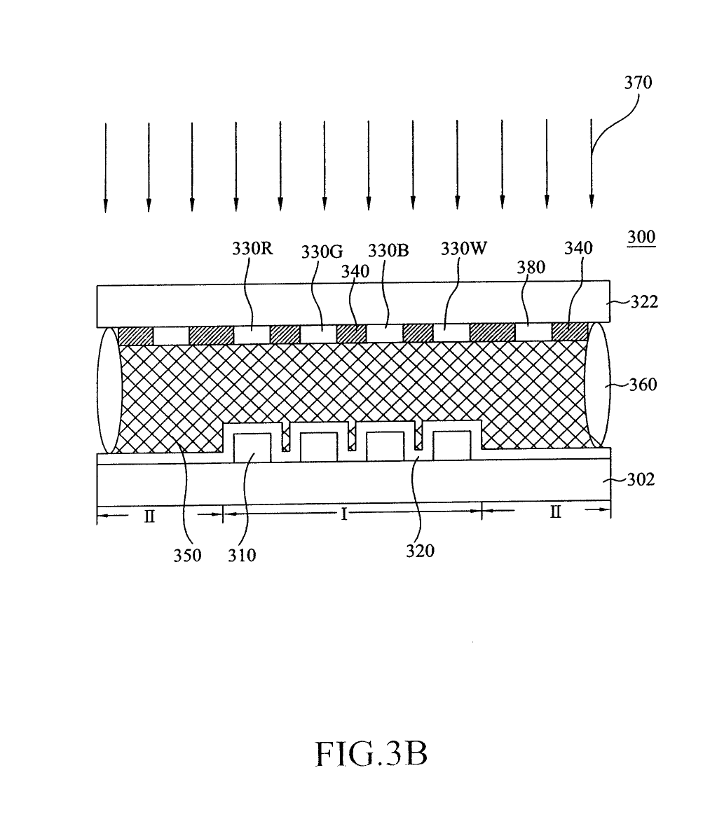

FIG. 3A is a plan view illustrating an OLED display panel in accordance with another embodiment of the present invention. FIG. 3B is a cross-sectional view taken along with a cross-section line BB′ of FIG. 3A. This embodiment differs from that of FIGS. 2A and 2B in that not only the light transmittable layer 380 but the light shielding layer 340 are disposed under the upper substrate 322 within the non-display region “II”, and that an area ratio of the light transmittable layer 380 to the non-display region “II” is between 60 and 99. Other portions are similar to those shown in FIG. 2A and 2B and hence redundant description is omitted.

As shown in FIG. 3B, in this embodiment, because the area ratio of the light transmittable layer 380 to the non-display region “II” is between 60 and 99, the filling layer 350 is also cured by exposing to light from the light source 370. That is, light from the light source 370 passes through the light transmittable layer 380 and directly illuminates the filling layer 350 under the light transmittable layer 380. In doing so, the filling layer 350 shown in FIG. 3B is cured effectively the same as that shown in FIGS. 2A and 2B.

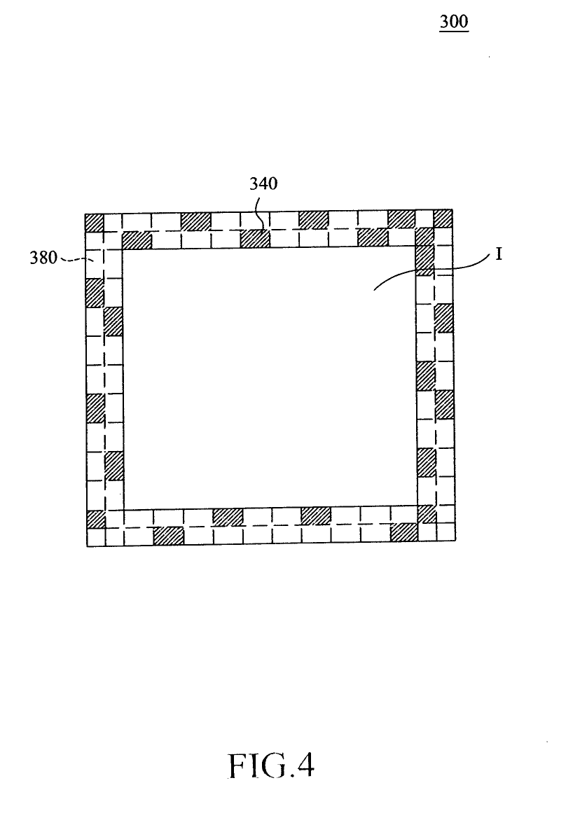

As shown in FIG. 3A and 3B, the light shielding layer 340 and the light transmittable layer 380 are disposed in a stripe arrangement. Alternatively, the light shielding layer 340 and the light transmittable layer 380 are disposed in a mosaic arrangement, as shown in FIG. 4.

In other embodiments, the color filters 330R, 330G, 330B, and 330W can be replaced with color filters consisting of red, blue and green colors.

The upper and lower substrates in the aforementioned embodiments can be glass substrate, plastic substrate or silicon wafer. Alternatively, the lower substrate can be thin film transistor substrate or passive matrix substrate. The passivation layer in the aforementioned embodiments can be made of silicon oxide, silicon nitride, silicon oxynitride or a combination thereof, e.g. inorganic materials. The light shielding layer in the aforementioned embodiments can be made of chromium.

The display panel in the aforementioned embodiments can be top emission type or bottom emission type display panel.

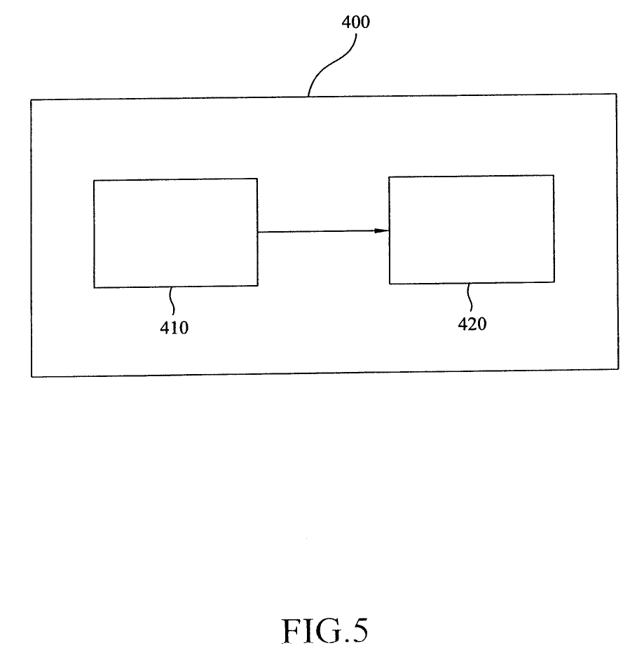

As shown in FIG. 5, one embodiment of the invention also discloses an electronic device 400. The electronic device 400 includes a display panel 420 and an input unit 410 coupled to the display panel 420, and the input unit 410 transmits signals to the display panel 420 so as to display images thereon. The display panel 420, for example, refers to the display panel 300 shown in FIG. 2B or FIG. 3B. Additionally, the electronic device 400 may be a mobile phone, a digital camera, a personal digital assistant, a laptop computer, a desktop computer, a television, an automotive display device, or a portable DVD player. The display panel 420, for example, may be an OLED display device.

Although specific embodiments have been illustrated and described, it will be obvious to those skilled in the art that various modifications may be made without departing from what is intended to be limited solely by the appended claims.

1. An image display system, comprising:
a display panel having a display region and a non-display region adjacent thereto, the display panel comprising:
an upper substrate including a light transmittable layer within the non-display region of the upper substrate, wherein the light transmittable layer has a transmittance at a specific wavelength of light;
a lower substrate opposing to the upper substrate;
a plurality of organic light-emitting diodes on the lower substrate; and
a filling layer including a light curable material , the filling layer disposed between the upper and lower substrates and covering the display region and the non-display region of the lower substrate, wherein the light curable material is cured by absorption of the specific wavelength of light.

2. The image display system of claim 1, wherein the light transmittable layer is a blue resist layer, a red resist layer or a green layer.

3. The image display system of claim 1, wherein the specific wavelength is ranged from 300 nm to 430 nm.

4. The image display system of claim 1, wherein the transmittance is larger than 10%.

5. The image display system of claim 1, wherein the light curable material is UV curable material.

6. The image display system of claim 1, wherein the upper substrate further comprises a light shielding layer disposed adjacent to the light transmittable layer and within the non-display region.

7. The image display system of claim 6, wherein the light shielding layer and the light transmittable layer are disposed in a stripe arrangement.

8. The image display system of claim 6, wherein the light shielding layer and the light transmittable layer are disposed in a mosaic arrangement.

9. The image display system of claim 6, wherein an area ratio of the light transmittable layer to the non-display region is between 60 and 99.

10. The image display system of claim 1, wherein the display panel further comprises:
a passivation layer covering the organic light-emitting diodes.

11. The image display system of claim 1, further comprising:
a display device including the display panel, wherein the display device is an OLED display device.

12. The image display system of claim 1, further comprising:
an electronic device, including:
the display panel; and
an input unit coupled to the display panel, the input unit transmitting signals to the display panel so as to display images thereon.

13. The image display system of claim 12, wherein the electronic device is a mobile phone, a digital camera, a personal digital assistant, a laptop computer, a desktop computer, a television, an automotive display device, or a portable DVD player.
